(19) United States
(12) Patent Application Publication
(10) Pub. No.: US 2004/0253097 A1
(43) Pub. Date: Dec. 16, 2004

(54) Hydropowered turbine system

(76) Inventor: David T. Kao, Gainesville, VA (US)

Correspondence Address: David T. Kao, 7941 Amsterdam Court, Gainesville, VA, 20155, US

(21) Appl. No.: 10/863,134

(22) Filed: Jun. 8, 2004

(30) Foreign Application Priority Data
Jun. 11, 2003 (CN) 03129238.0

(51) Int. Cl. F03D 7/00

(52) U.S. Cl. 415/204

(57) ABSTRACT

A hydropowered turbine system is designed to provide a more rational structural arrangement, improved unit operating efficiency, and minimized negative environmental and ecological impact. The system has a hollow base member with an inlet fluid conduit at its upper end in contact with retained water under pressure. Fixed at the fluid flow inlet into the turbine runner section are a number of arcuate shape guiding vanes with variable curvatures closely coincide with the inward and upward helical streamlines of the turbine flow. A flared fluid outlet is located above the inlet fluid conduit. A buoyant needle valve is slidably mounted in the base member to open or close fluid flow through the fluid outlet. A turbine runner is mounted over the fluid outlet and includes a vertical shaft connected to a generator. A plurality of turbine blades is fixed on the lower end of the shaft adjacent the fluid outlet. The upper edges of the blades are parabolic in shape and dwell in a parabolic plane. A flume ring is connected to intermediate edges of the blades and has an outer-surface which is flared compatibly with the flared fluid outlet into which is extends and is affixed on it a number of sealing rings to minimize water leakage and viscous drag energy loss. A wedged-shaped space defined between adjacent blades, the vertical rotor shaft, and the flume ring forms a progressively upwardly and outwardly divergent flow passageway from the bottom towards the top of the turbine runner.

### BACKGROUND OF THE INVENTION

Hydroelectric turbine systems have long been used as a source of electrical power. The efficiency of these devices has improved over the years, as illustrated in the devices of U.S. Pat. Nos. 4,441,029; 5,780,935 and 6,239,505.

However, existing systems comprising valves, gates, and blades operated generator output shafts placed in a fluid flow still have certain shortcomings. Among the shortcomings are the inabilities to effectively aerate and recondition the water passing through the system wherein the liquid flow comes from a source deep behind a retaining dam where the water is short on oxygen among other deficiencies. More specifically they do not do an effective job of combined agitation and aeration of exit water. This is caused by incorrect positioning of the turbine runner relating to the tailrace, and improper use of all of the kinetic energy created by the system.

A further shortcoming of the hydropower turbine systems in the art is that the blades on the turbine runner are not easily and efficiently adjusted to meet different operating conditions. An additional shortcoming of the existing systems is that they include sharp or protruding surfaces which contribute greatly to fish mortality.

It is therefore a principal object of this invention to provide a hydropower turbine system wherein the turbine runner blades are partially submerged in the tailwater for achieving maximum aeration and turbulent mixing.

A further object of this invention is to provide a hydropowered turbine system wherein the turbine blades have upper arcuate edges which dwell in a parabolic plane, and intermediate edges surrounded by a flume ring for blade stability, and to prevent short-circuiting flow paths and fluid leakage losses.

A still further object of this invention is to provide a hydropowered turbine system wherein the water flows upward in the opposite direction of gravitational acceleration wherein equally spaced turbine blades have progressively increasing cross sectional area outwardly flow passageways therebetween optimizing the utilization of potential and kinetic energy contained in the passing water.

A still further object of this invention is to provide a hydropowered turbine system whereat the flow inlet a number of arcuated guiding vanes having curves correspondingly to the upward spiral streamlines to reduce fluid flow turbulence and enhance efficient utilization of the water flow energy.

A still further object of this invention is to provide a hydropowered turbine system wherein the turbine blades have upper edges which dwell in a parabolic plane to provide high theoretical kinetic energy recovery efficiency and wherein a component of the kinetic energy is useful in the aeration of the exiting liquid.

A still further object of this invention is to provide a buoyant needle valve flow control which can have its operating position efficiently controlled by means of a positive displacement pump.

A still further object of this invention is to have a hydropowered turbine system which can be easily serviced and maintained.

A still further object of this invention is to provide a hydropowered turbine system which is essentially free from sharp edges and protuberances and which will otherwise decrease fish mortality.

This machine is specifically an improvement over the device of said U.S. Pat. No. 6,239,505.

These and other objects will be apparent to those skilled in the art.

### SUMMARY OF THE INVENTION

The hydroelectric turbine of this invention has a base member with a fluid inlet and a fluid outlet. The fluid outlet is above the fluid inlet and is positioned to allow fluid exiting the base member to exit in an upward direction. A vertical rotor shaft has upper and lower ends and a vertical elongated connecting axis. The rotor shaft is normally supported by the input shaft of an electrical generator. The rotor shaft has a gradually increasing radius with the locus of their end points conforming to a nonlinear vertical curve to guide the upward water flow to flow also outwardly as it reaches the top of the outlet. The lower end of the rotor shaft is positioned adjacent the fluid outlet of the base member. A plurality of equally spaced arcuate blades having upper edges is secured to the end of the shaft adjacent the fluid outlet and partially extends into the fluid outlet. The upper edges of the blades have a parabolic shape and dwell within a parabolic-shaped arcuate plane. The rotor shaft and vertical elongated axis are usually supported as a part of the electric generator axis.

The blades have a wedge-shaped space therebetween which enlarges in an upwardly direction to create a progressively outwardly divergent flow passageway. The blades have an arcuate inner edge secured to the rotor shaft which extends in a helical direction with respect to the outer surface of the shaft. The blades are positioned with respect to the fluid outlet so that the direction of fluid flow upwardly from the base member will be perpendicular to the parabolic-shaped arcuate plane defined by the upper edges of the blades.

A flume ring is secured to intermediate edges of the blades and has a flared outer-surface complementary in shape to a flared inner surface of the fluid outlet and affixed on its outer-surface a number of sealing rings to minimize water leakage and frictional energy loss due to fluid viscosity.

A needle valve assembly is slidably mounted for vertical movement within and interior compartment of the base and is adapted to be moved from a lower open position to a closed upper position with respect to the fluid inlet. Fluid conduits are provided to permit fluid to be introduced into and from the lower portion of the base member below the needle valve to adjust its position. A second fluid conduit is also used to connect the fluid inlet with the bottom portion of the base member to equalize the fluid pressure therebetween at times.

The method of use of the turbine includes submerging the turbine with respect to the tailwater surface of a retaining dam so that the blades will be partially submerged below the tailwater surface and partially extending thereabove wherein the blades will cause water droplets to be propelled upwardly and outwardly over the tailwater surface surrounding the fluid outlet while at the same time causing turbulent water mixing below the tailwater surface. The “turbulent mixing” action itself is designed to also aerate the water. The formation of air-born droplets (to increase air-water contact surface for effective aeration) and the subsequent re-entry (bringing with them air bubbles) and mixing of the droplets (as well as the air bubbles) into the water around the discharge outlet are designed to enhance the effectiveness of aeration induced by the turbulent mixing.

### THEORY AND OPERATION OF THE INVENTION

One of the principal environmental issues directly related to hydropower generation is its impact on downstream water quality. Impoundment of water can cause considerable alteration of water quality characteristics from the quality regime of the natural stream. The most significant water quality alteration results from the temperature and dissolved oxygen stratification that takes place in the reservoir. The negative impact on downstream water quality becomes more predominant when the water for the hydropower generation is taken, as is frequently the case, from the Hypolimnion depth in the reservoir where dissolved oxygen is very low or completely absent (e.g. below a depth of 30 feet). Depending upon the local conditions, water at this depth can also contain very high amounts of dissolved nitrogen. The conventional hydropower turbine system permits the water to pass through a closed conduit to discharge under submerged flow condition from the intake through the tailrace into the downstream channel. This severely limits the aeration and saturated gas stripping potential of the discharge water.

In the turbine 10, water flows upwardly through the turbine runner and exits freely into the atmosphere near the water surface 16 in the tailrace 14. This fundamental change in design enhances the natural aeration process, air entrainment, and turbulent mixing for both absorption to increase dissolved oxygen and desorption to strip away the over-saturated gas such as nitrogen and helps improve water quality in the downstream channel.

In order to achieve the optimum result for air bubble entrainment and air-water mixing, the turbine blades 80 need to be partially submerged under water surface 16 and partially exposed to the atmosphere as shown in FIG. 7. The exposed portion of the turbine runner 77 and blades 80 allows water to spread directly into atmosphere forming water drops 114 (FIG. 7) to increase the air-water contact surface. As these water drops re-enter, they bring air bubbles 116 (FIG. 7) into the tailwater 14 augmenting air entrainment. The submerged part of the turbine blades will use the blade motion, as well as residual kinetic energy to create turbulent mixing action. (See arrows 118 in FIG. 3). This will further increase air-water contact and enhance absorption and desorption processes.

Because the fluid flow through turbine 10 is in an upward direction, it is possible to achieve certain advantages. Among these is the ability to minimize residual kinetic energy loss in the discharge water and to improve overall hydropower plant efficiency. For the similar partial kinetic energy recovery, the conventional system relies on a long and costly draft tube. This invention permits the recovery of a portion of the residual exit flow kinetic energy. In designing a runner-diffuser, the fundamental consideration is to prevent potential flow separation from the surface of the runner blade. The fluid dynamic theories one can use to guide the diffuser design include the theory of boundary layer separation and energy conservation principle of flow through gravitation field.

The boundary layer separation theory can be simply stated as follows: A point of flow separation is reached when the velocity gradient in the direction normal to the direction of flow within the boundary layer (y=0) vanishes.

[∂Vₓ/∂Y]_{Y=0}=0

Where Vₓ=velocity component in x-direction which is in the normal (perpendicular) direction of Y.

By applying this theory to flow in a horizontal conduit system the angle of boundary divergence is limited to normally not exceeding 7 to 9 degrees in the direction of the flow. This angle is even more restricted in a system with downward flow. This helps to explain why a conventional downward or horizontal flow hydropower generation system must use a very long draft tube in order to recover any significant amount of kinetic energy from the turbine discharge flow.

Since the fluid flow through turbine 10 is upwardly, the fundamental principle of energy conservation can be used to prevent flow separation. Thus, while energy contained in a fluid flow system may exist in a combination of different forms namely: potential energy, kinetic energy, and/or elastic (pressure) energy, and may convert in full or in part from one form or another due to changing flow conditions, its total amount remains the same.

$$[ ρ g z + \frac{ρ {v}^{2}}{2} + P ] = K$$

Where

ρ=mass density of water;

g=gravitational acceleration constant;

z=elevation;

v=flow velocity;

P=pressure; and

K=constant

As the flowing water passes through a well engineered reaction turbine runner, the pressure head contained in the flow is totally converted to work done on the turbine-generator unit. By applying this principle one can determine the magnitude of velocity reduction as a function of the elevation increase (conversion of kinetic energy to potential energy) or vice versa as water flow upward through the turbine runner using the following relationship:

[velocity]²reduction=[2×gravitational acceleration×elevation increase]

Δ(v)²=(−)2gΔz

Where

V=flow velocity;

g=gravitational acceleration constant;

Z=elevation; and

(−)=indicates velocity decrease as elevation increases (depending also on the sign convention adopted).

This equation can be used in the design of the divergent flow passage way formed by the adjacent turbine runner blades 80. This relationship is uniquely applicable for the updraft flow through a reaction turbine with a near free surface discharge flow arrangement as presented in turbine 10. It does not apply to turbine flow systems operating under closed conduit flow conditions through a restricted cross sectional area like those used in conventional hydropower generation systems.

In the actual design process of the turbine runner 77 one can estimate the maximum permissible exit flow area based on the mass conservation principle. This principle is commonly expressed in terms of equation of continuity which is written for velocity component normal to the flow area under concern and takes the form of

[Velocity×Area]_{@section-i}=[Velocity×Area]_{@section-e}

Where (i) represents a section near the inlet and (e) represents a section near the exit. In equation form:

[Vₙ*A]ᵢ=[Vₙ*A]ₑ

Where Vₙ=velocity component normal to flow area A.

The product of velocity and area at inflow section-i is determined by the flow condition of the hydropower plant site. The velocity at the exit section-e is computed using the energy conservation principle described above. The only remaining unknown parameter, area at the exit section-e, can then be readily determined. The computed area gives the limiting value for the exit flow cross sectional area. Selection of a smaller exit flow area than the computed value will, in most cases, automatically satisfy the boundary layer separation theory, as well as the flow through gravitational field. Once the exit flow velocity is known, the kinetic energy recovery efficiency can be determined.

By comparing blades that are circular in shape, with the parabolic-shaped edges 82 on blades 80, it has been determined that the blades 80, whose edges 82 dwell in a parabolic-shaped plane, yield a higher discharge water velocity especially along the center portion of the exit flow area and gives potentially more effective water spread. Furthermore, a parabolic-dome does not rise as high above the tail water elevation at the middle portion of the turbine and therefore does not sacrifice as much effective head as in the spherical dome case.

The hemispherical dome which provides larger exit flow area, thus, a smaller discharge water velocity, can achieve a theoretical kinetic energy recovery efficiency of [{1−(1/21.73)}×100=95.4%}. This is higher than the conventional draft tube kinetic energy recovery efficiency which is normally designed for approximately at [{1−(1/16)}×100=94%]. On the other hand, the parabolic-dome design of blades 80 gives a theoretical kinetic energy recovery efficiency of [{1−(1/8.65)}×100=89.4%] for a similar turbine size and dimensions. This means that the latter design leaves more residual velocity to work for aeration and turbulent mixing to improve downstream water quality.

A needle valve is known for providing high operating efficiency over a broad range of flow conditions. In turbine 10, the needle valve 56 is designed to operate in the vertical position as an integral part of the uniform radial inflow distribution system. By connecting the lower portion of compartment 38 below the needle valve 56 through the small pressure transmission tube 50 to the turbine flow system itself, the needle valve 56 can be balanced to be near neutrally buoyant. This allows the operation of the needle valve 56 to take place by using hydraulic means with very little external power. The hydraulic fluid (water can be used) needed for operating the needle valve 56 is supplied through conduits 42 and 46 and positive displacement pump 44 as described above.

During the needle valve opening operation, the water pressure in the lower chamber beneath the needle drum can be partially released by means of the small reversible positive displacement pump 44 through tube 46. This will create a partial vacuum inside the lower portion of compartment 38 to allow the atmospheric pressure exerted on the upper part of the needle valve 56 to push the valve downwardly to an open position. This further ensures easy operation of the needle valve with a minimum of external power supply.

Conventional hydropower generation lets the high-pressure water flow to enter the turbine-generator unit around the power transmission shaft between the turbine and the generator. This type of arrangement requires the use of a high-pressure seal around the rotating shaft to prevent water leakage into the generator housing and to periodically re-pack the “stuffing box” containing the sealing material. Depending upon the specific method adopted in its design, such periodical maintenance operations can be frequent and difficult and cause undesirable power generation outages. Because of the use of a vertical upward flow and the free surface exit water discharge arrangement of turbine 10, the generator shaft 30 is placed at the downstream (low energy) side of the turbine runner and above the normal tailwater surface 16. This new design provides several distinct advantages. It eliminates the potential of high pressure water seeping along the rotating power transmission shaft into the generator housing. It provides easier accessibility for system installation and maintenance. It increases the flexibility for modular system construction.

By allowing free surface water discharge without a draft tube, the new hydropower turbine system herein does not have flow cavitation. Exposures to hydrodynamic shock and to cavitation (partial vacuum) pressure in the draft tube of existing turbines are among the principal causes for injuries and mortality to fish moving through the system.

Fish mortality related to hydropower generation may be a result of combination of causes including external injuries (striking on the flow obstructing elements such as wicket gates), internal injuries (passing through cavitation pressure zone), and oxygen deficiency in the water downstream. Gas-bubble diseases due to super-saturation of nitrogen have also been cited as a possible cause. Turbine 10 will reduce the potential for external and internal fish injuries through reduction of elements of flow obstruction and elimination of cavitation. Fish mortality is also reduced by improvement of the water quality in the downstream channel through aeration and gas stripping. As a result of these fundamental design changes, the reduction of fish mortality can thus be expected.

From the foregoing, it is seen that this invention will achieve at least all of its stated objectives.

### DESCRIPTION OF DRAWINGS

FIG. 1 is a perspective view of the hydropowered turbine of this invention;

FIG. 2 is an exploded view at a smaller scale of the components of FIG. 1;

FIG. 3 is a large scale perspective view of the turbine blades mounted on the turbine runner;

FIG. 4 is a sectional view of the turbine runner taken on line 2B-2B of FIG. 3, and shows the upper edges of the turbine blades;

FIG. 5 is a bottom view of the turbine runner taken on line 2C-2C of FIG. 3 and shows the bottom edges of the turbine blades;

FIG. 6 is a perspective view of a flume ring which is, in the assembled unit, secured to the turbine blades;

FIG. 7 is a partial sectional view of the upper portion of the turbine of this invention showing its partially submerged condition and showing it in operation;

FIG. 8 is a section view of the guiding vanes with curved surface closely coincides with the inward and upward helical streamlines of the turbine flow taken on line 3A-3A of FIG. 7;

FIG. 9 shows a family of streamlines constructed by combining streamlines of flow around a sink and that of vortex flows;

FIG. 10 is a conceptual illustration of a helical streamline;

FIG. 11 is an enlarged longitudinal sectional view of the turbine of this invention as shown in FIG. 13 and showing the needle valve in its maximum open position;

FIG. 12 is a sectional view of the turbine of this invention similar to that of FIG. 11 but showing the needle valve in its closed position;

FIG. 13 is a reduced scale sectional view of the turbine of this invention mounted in the environment of a hydroelectric dam and being positioned in the tailwater of the dam.

### DESCRIPTION OF THE PREFERRED EMBODIMENT

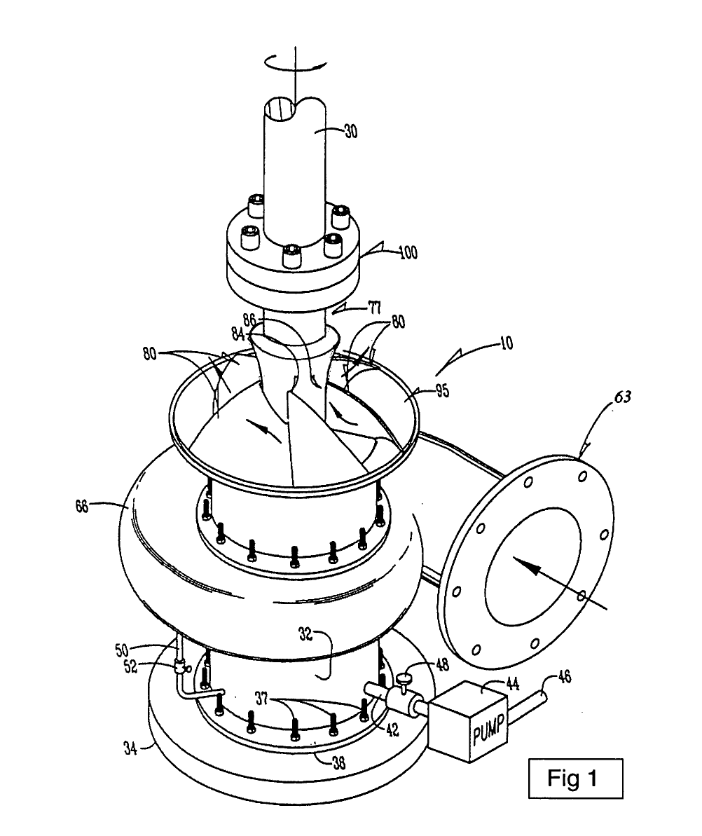

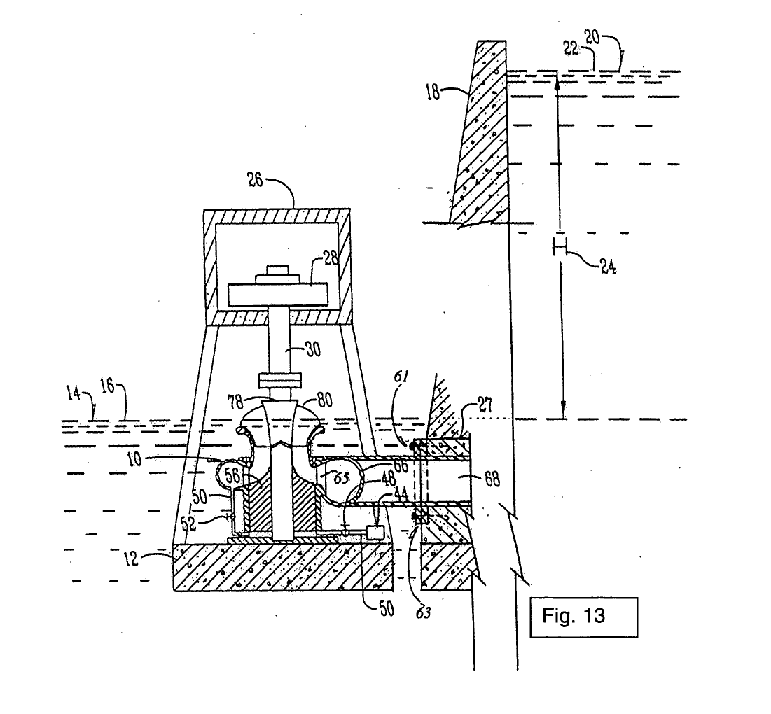

The numeral 10 designates the hydroturbine of this invention and is shown primarily in FIGS. 1 through 13. With reference to FIG. 13, the hydroturbine 10 is supported on a foundation 12 in the tailwater 14 having a surface 16 which is located below a retaining dam 18. The conventional dam 18 typically retains water 20 having an elevated surface 22 with respect to the surface 16. The letter H, designated by the numeral 24 represents the head between surfaces 22 and 16.

A generator housing 26 is mounted on a foundation 12 and houses conventional electrical generator 28. Generator 28 has a vertically disposed generator input shaft 30.

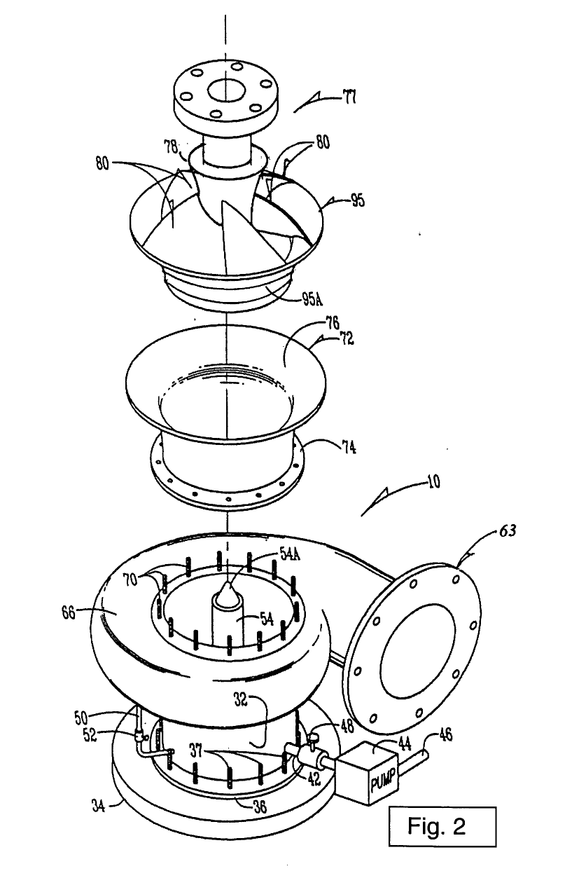

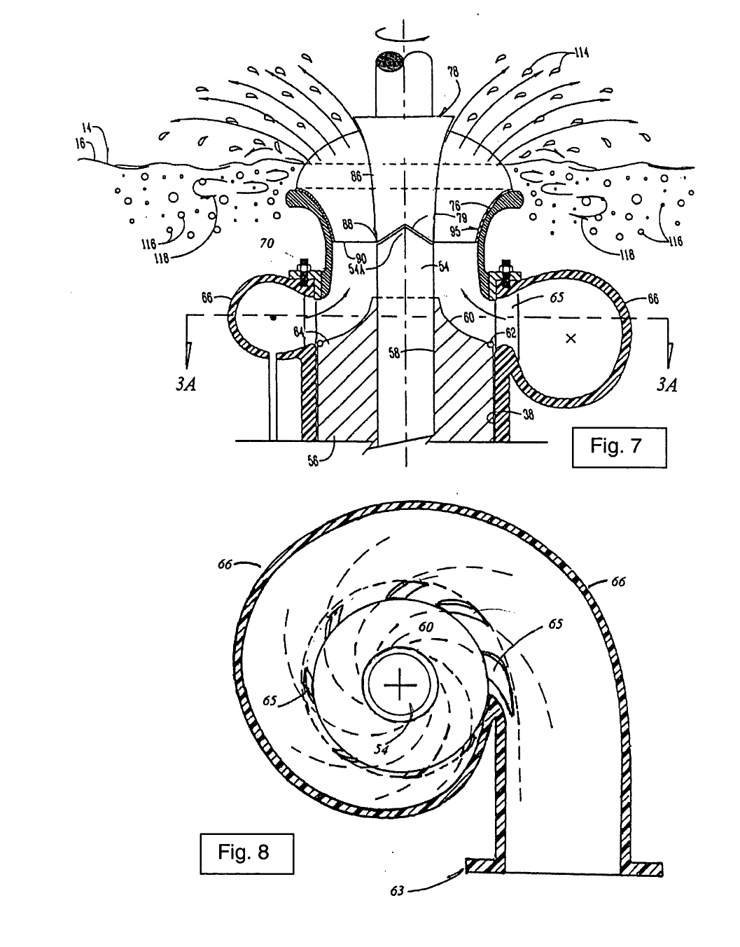

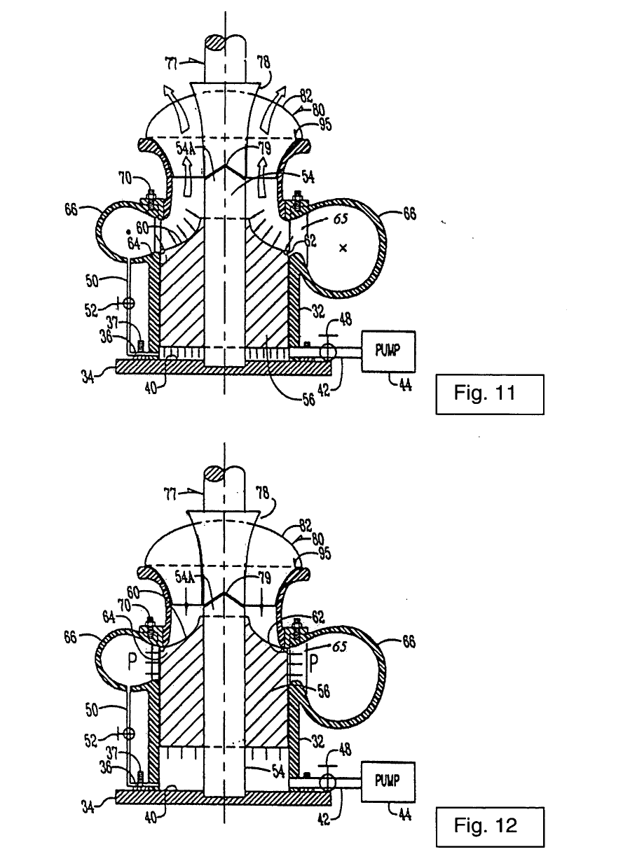

Turbine 10 includes a cylindrical hollow base 32 which has a bottom 34 (FIGS. 2, 11 and 12). The base 32 has a lower horizontal flange 36 which is secured to bottom 34 by a plurality of conventional nut and bolt assemblies 37 (FIG. 1). The cylindrical base has an interior cylindrical compartment 38 (FIG. 7) which has a bottom end 40 (FIGS. 11 and 12). The lower end of cylindrical compartment 38 of base 32 is in communication with a fluid conduit 42 (FIGS. 1 and 2) which is in communication with a reversible positive displacement pump 44, which is in turn connected by fluid conduit 46 to a source of fluid. The controls for pump 44 are conventional and the operation and direction of fluid flow from pump 44 can be manually or computer controlled. A valve 48 is imposed in conduit 42. Valve 48 can also be remotely controlled in a manner similar to that of pump 44.

A small tube 50 with valve 52 imposed therein extends between the bottom end 40 (FIGS. 11 and 12) of the cylindrical compartment 38 and the fluid inlet of the turbine as will be discussed hereafter. The valve 52 can be operated in the same manner as valve 48. The diameter of tube 50 would typically in the order of ⅜th's inch, as compared to the diameter of conduit 42 which would be in the order of ¾'s inch to one inch.

A needle valve shaft 54 (FIG. 12) is disposed in a vertical position and is located in the center of bottom 34 of base 32. A needle valve 56 is slidably mounted on shaft 54 by means of vertical bore 58 (FIG. 7) which extends through the needle valve 56. The top portion 60 of valve 56 is concave in shape and has a circular seal ring 62 extending around shoulder 64 which is the intersection of the concave portion 60 and the sidewalls of the valve 56.

A spiral case inlet flow conduit 66 is integral with the cylindrical base 32 as best shown in FIGS. 7, 11 and 12. The spiral case conduit 66 is in communication with the cylindrical compartment 38 and is connected, using conventional flanges joined together by bolts and nuts, with fluid inlet conduit 68 which in turn is in communication with the retained water 20 at the bottom of dam 18 (FIG. 13).

With reference to FIGS. 2 and 7, upstanding bolts 70 are imbedded in the upper portion of inlet conduit 66 to receive the outlet flume 72 through suitable apertures in the lower flange 74 connected to the lower perimeter of flume 72. The upper portion of the flume 72 is flared outwardly at 76 and comprises the fluid exit portion of the turbine. FIG. 11 shows the needle valve in its open position and FIG. 12 shows the needle valve in its closed position. The needle valve is moved from the position in FIG. 11 to the position in FIG. 12 by first closing the valve 52 in small tube 50, and then opening the valve 48 in conduit 42. The pump 44 is energized to bring fluid under pressure into the bottom of cylindrical compartment 38 thus causing the needle valve 54 to slidably rise in the compartment 38 on needle valve shaft 54. The needle valve 56 can be raised to any degree desired up to the maximum closed position shown in FIG. 12. When the needle valve is moved to its desired position, the valve 48 is closed, and the valve 52 is opened so as to balance the hydraulic pressure in the conduit 66 and the lower end of the compartment 38. The needle valve 56 is moved from the closed position of FIG. 12 to an open position of FIG. 11 by reversing the above described procedures whereupon the valve 52 in small tube 50 is closed, the valve 48 in conduit 42 is opened, pump 54 is reversed so as to withdraw fluid from the bottom of compartment 38. When the needle valve is lowered to its desired position, the operation of the pump is stopped, the valve 48 is closed, and the valve 52 is opened.

With reference to FIGS. 1 through 13, a turbine runner 77 has a vertically disposed turbine output shaft 78 with a plurality of turbine blades 80 welded or otherwise secured thereto. As shown in FIG. 12, the lower end of shaft 78 has a conically shaped depression 79 which receives a conically shaped protrusion 54A on the upper end of needle valve shaft 54.

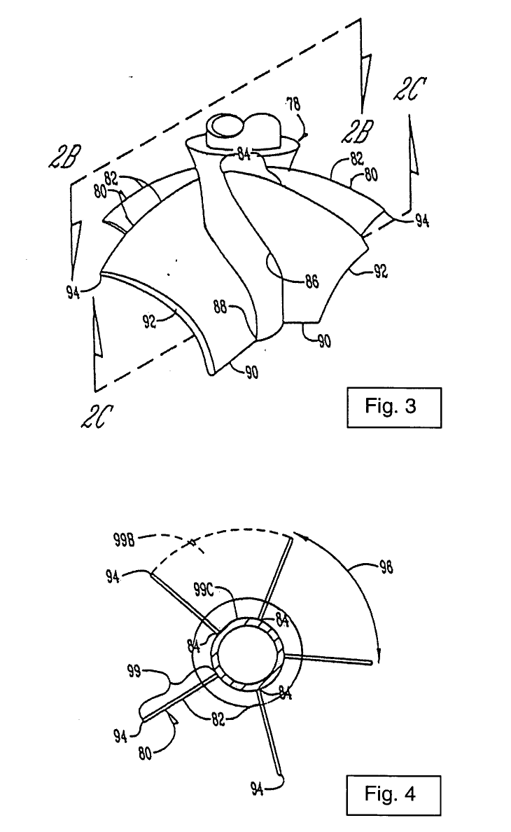

Turbine blades 80 (FIG. 11) have upper edges 82 that are in the shape of a parabola and which all dwell in a parabolic-shaped plane. The numeral 84 designates the upper ends of the blades. Extending downwardly in a helical path from the upper ends 84 of the blades is an inner edge 86 which has a lower end 88 (FIG. 3). The inner edges of the blades extend in a helical path along the outer surface of the shaft 78. The blades have a bottom edge 90 which extends outwardly in a horizontal direction from the lower ends 88 of the inner edges 86 of the blades. An intermediate edge 92 on each blade extends upwardly and outwardly from the outer end 90 of the blades to conform to the flared surface 76 (FIG. 2) of the outlet flume 72. The numeral 94 designates the lower end of the upper edge 82 of the blades.

A flume ring 95 (FIG. 6) is secured in any convenient fashion to the intermediate edges 92 of the turbine blades 80. The flume ring 95 has a flared outer surface 95A which is compatible in shape to the flared surface of 76 of outlet flame 72. One or several leakage prevention rings 95C are secured on the outer surface 95A of the flume ring. Use of leakage prevention rings can significantly reduce the viscous drag resistance created due to the otherwise require tight fit between the rotating flume ring 95 and the stationary outlet flume 72. Flume ring 95 has a center opening 95B. Flume ring 95 reinforces the blades 80 secured to it along their edges 92 and reduces possible water flow short circuiting. The inner surface “depth” of flume ring 95B substantially equals to the projected length of intermittent outer edges 92 of the blades 80 on the vertical meridian plane passing through the centerline of the rotor shaft.

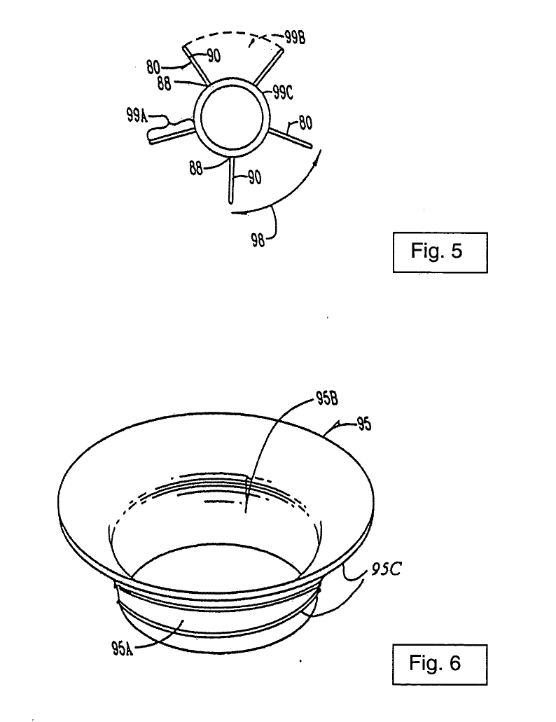

With reference to FIG. 4, the arrow 96 designates the radially varied circumferential distance between the upper end 84 of blade 80 and the upper end 84 of the next adjacent blade 80. Similarly, the arrow 98 (FIG. 5) designates the radially varied circumferential distance between the lower end 88 of blade 80 and the lower end 88 of the next adjacent blade 80. The distance represented by arrow 98 is less than the distance designated by arrow 96 so that the volume of space between adjacent blades progressively is increased from the bottom end to the top end of the blades because the radial length 99 (FIG. 4) of the upper edges 82 is greater than the radial length 99A (FIG. 5) of bottom edges 90.

A wedge-shaped space 99B (FIGS. 4 and 5) exists between adjacent blades 80 and is defined by the parabolic plane encompassing upper edges 82, the surface area of the blades, a horizontal plane passing through the bottom edges 90 and the exposed surface 99C (FIGS. 4 and 5) of shaft 78 between the helical inner edges 86. Thus, a progressively upwardly and outwardly divergent flow passageway is formed from the bottom to the top of space 99B.

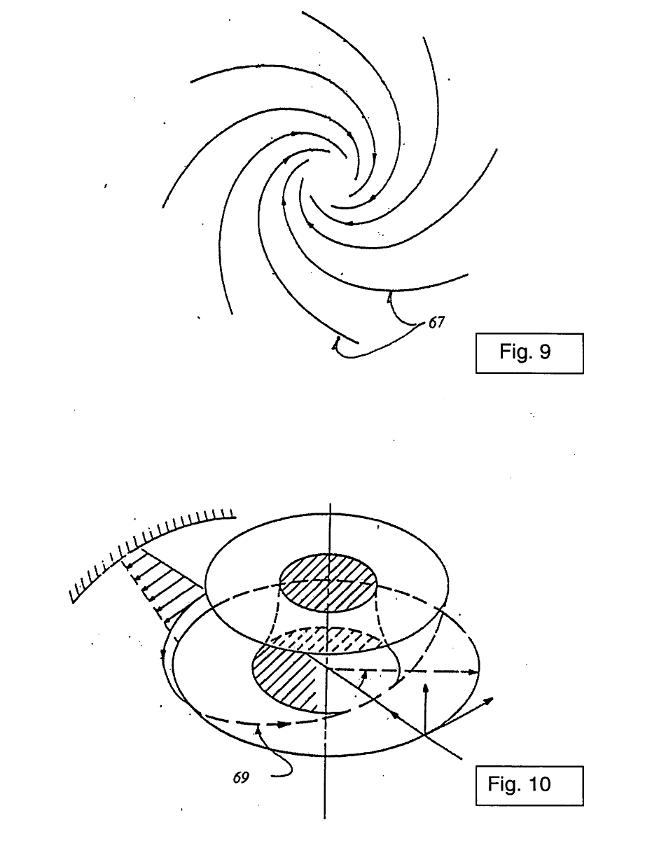

With reference to FIGS. 7 and 8, a set of plural number arcuate shaped guiding vanes 65 is installed along the circumference where the spiral case inlet flow conduit 66 and outlet flume 72 connects. Based on the hydrodynamic theory, the fluid inside the spiral case conduit 66 flows along the direction of the spiral streamlines 67 (FIG. 9). After the fluid enters the chamber of turbine rotor 77, it begins to flow also upwardly. The vector sum of the original spiral streamlines and the upward flow velocity component forms an upward helical flow 69 as depicted in FIG. 10. In order to avoid interrupting and disturbing the flow streamlines, the guiding vanes 65 adopt an arcuate shape complimenting that of the helical flow line at their respective locations. Their projection on the vertical plane parallel with the radii has a horizontal dimension that decrease in size in accordance with the decrease of the radius of the spiral case inlet flow conduit. This helps to keep the ratio of the guiding vane area to the cross sectional area of the spiral case conduit at various point near a constant value, and more uniformly distributing the inflow discharge from the spiral case to the turbine.

arcuate shape with variable curvatures closely coincide with the inward and upward helical streamlines of the turbine flow; they are evenly distributed around and fixed at the fluid flow inlet; and their projection on the vertical plane parallel with the radial line have horizontal dimensions that reduce gradually correspondingly with the reduction of the radius of the inflow spiral case.

A conventional coupling 100 is used to join the lower end of generator input shaft 30 and the upper end of turbine outlet shaft 78 (FIG. 1).

What is claimed is:

1. A hydropowered turbine, comprising,
a base member (32) having a directly connected on the outer periphery spiral-case fluid inlet conduit (66),
a set of plural number guiding vanes (65) at the fluid flow inlet, an upwardly and outwardly flared-shaped fluid outlet (72) in the base member above the fluid inlet and being positioned to allow fluid exiting the base member to exit in an upward direction,
a vertical rotor shaft (78) having lower and upper ends and a vertical elongated axes (30), means for supporting the rotor shaft with one end thereof adjacent the fluid outlet,
a plurality of arcuate spaced blades (80) having inner edges (86) secured to the end of the shaft adjacent the fluid outlet, and having intermediate edges symmetrical in shape to the shape of the upwardly and outwardly flared-shape of the fluid outlet,
a flume ring (95) symmetrical in shape to the outwardly flared shape of the fluid outlet secured to the intermediate edges of the blades and partially extending downwardly into the fluid outlet,
and a hollow drum shape needle valve (56) to slide up-and-down inside the lower base member cylinder (38) for fluid flow adjustment.

2. The device of claim 1 wherein said guiding vanes have arcuate shape with variable curvatures closely coincide with the inward and upward helical streamlines of the turbine flow; they are evenly distributed around and fixed at the fluid flow inlet; and their projection on the vertical plane parallel with the radial line has horizontal dimension that decrease in size gradually in accordance with the decrease of the radius of the inflow spiral case.

3. The device of claim 1 wherein said blades have lower edges having a radial length less than the length of said upper edges, have an arcuate inner edge secured to said rotor shaft, and extending in a helical direction with respect to the outer surface of said shaft, and are positioned with respect to said fluid outlet to allow fluid flow to exit upwardly and outward from said base member perpendicular to the parabolically shaped spherical plane defined by the upper edges of said blades.

4. The device of claim 1 wherein said arcuate blades has their outer edge of the intermediate section fixed on the said flume ring which has a flared outer-surface complementary in shape to a flared inner surface of the fluid outlet and affixed on its outer-surface a number of sealing rings to minimize water leakage and frictional energy loss due to fluid viscosity.

5. The device of claim 1 wherein said vertical rotor shaft section located with respect to said fluid outlet has a gradually increasing radius with the locus of their end points conforming to a nonlinear vertical curve.

6. The device of claim 1 whereby a wedged-shaped space is defined between adjacent blades with the said parabolic plane defining the top of said space, and a horizontal plane passing through said lower edges defining the bottom of said space, with the area of the top of said space being greater than the area of the bottom of said space to create a progressively upwardly and outwardly divergent flow passageway from the bottom towards the top of said space.

7. The device of claim 1 wherein the base member has a hollow cylindrical compartment below the fluid inlet, a needle valve slidably mounted for vertical movement within said compartment, and adapted to be moved from a lower open position to a closed upper position above said fluid inlet, and a fluid conduit connecting said fluid inlet and said compartment at a location below said needle valve to permit the fluid pressure above and below said needle valve to be substantially equalized.

8. The device of claim 2 wherein the arcuate shaped guiding vanes have their radial direction inner edge curved in accordance with the upper outer edge of the said needle valve in its up-most limiting position.

9. The device of claim 7 wherein a fluid pump is fluidly connected to a source of fluid and to said compartment at a location below said needle valve to inject fluid under pressure into said compartment and to withdraw fluid out of said compartment to raise and lower, respectively, said needle valve within said compartment to effect the closing and opening, respectively, of said fluid inlet.
